(19) United States
(12) Patent Application Publication
(10) Pub. No.: US 2006/0195885 A1
(43) Pub. Date: Aug. 31, 2006

(54) Transmitter and receiver for determing locale

(75) Inventors: Petrus Johannes Lenoir, Eindhoven (NL); Sebastiaan Antonius Fransiscus Arnoldus Van Den Heuvel, Eindhoven (NL); Michael Abraham Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/547,325

(22) PCT Filed: Mar. 4, 2003
(86) PCT No.: PCT/IB04/50187

§ 371 Date: Aug. 30, 2005

Related U.S. Application Data
(60) Provisional application No. 60/451,919, filed on Mar. 4, 2003.

(30) Foreign Application Priority Data
Dec. 11, 2003 (EP) 03104640.2

(51) Int. Cl. H04N 7/16; H04N 11/00; H04N 7/00

(52) U.S. Cl. 725/136; 348/468; 348/461; 725/135; 725/138

(57) ABSTRACT

A transmitter (110) which transmits a signal (120) for reception by a receiving device (130). The transmitter is arranged to insert into the signal an indication of a geographical region where the signal physically can be received. Preferably the geographical region is indicated in the signal using geometrical shapes. The receiving device receives one or more signals, each of the signals carrying an indication of a respective geographical region where the respective signal physically can be received, and is arranged to determine its locale from said indications. The receiver can compute the intersection of the sets of geometrical shapes carried in the various signals it received as the geographical region it is in. Based on its determined locale the receiver can restrict access to content, if such content is restricted to certain regions.

Copy protection protects the owner of copyright material, such as entertainment material, from unauthorized distribution of the material. Purchasers of copyright material, however, expect to be able to copy the purchased material for their own convenience and enjoyment. Standards and techniques continue to evolve to provide copy protection systems that allow purchasers of protected material to freely copy the material, yet still provide the owner of the protected material some protection from widescale distribution.

One solution to this problem is to restrict distribution of content to a certain geographical region, for example one country. A DVD disc bought in the United States for instance can generally not be played back on a DVD player bought in Europe. A similar situation occurs for broadcasted content.

Regional restrictions in broadcast can be achieved by limiting the area in which the broadcast signal can be received. You can receive the signal if your antenna is located in the correct geographical area. This method is used by terrestrial as well as satellite broadcasters.

Another approach depends on the availability of devices such as set-top boxes (STBs). The device or service that is required to access the content can only be bought in a certain region. This method is used by Canal+ to limit the reception of Dutch television to the Netherlands (you have to buy the STB in the Netherlands and use a non-international phone call in order to activate you subscription).

It would be desirable if the device required to access the content can be purchased anywhere, yet will only accept content in the correct geographical area. For this to work, the device must know its locale. Options to achieve this range from a user setting to implementing a GPS receiver in each device. However, allowing the user to manually enter the location is not secure enough and a GPS receiver is too expensive.

It is an object of the invention to provide a way for receivers to determine their locale with reduced user intervention.

This object is achieved according to the invention in a transmitter for transmitting a signal for reception by a receiving device, the transmitter being arranged to insert an indication of a geographical region where the signal physically can be received.

This object is achieved according to the invention in a receiving device for receiving one or more signals, each of the signals carrying an indication of a respective geographical region where the respective signal physically can be received, the device being arranged to determine its locale from said indications.

The geographical region can be encoded in a variety of ways. Preferred solutions are to use the power level to be used for the transmission of the signal, or to indicate the geographical region using geometrical shapes, e.g. one or more rectangles. At the transmitting side it is possible to quite accurately determine in advance in which geographical region the transmission can be physically received. An indication of this region can then be inserted in the signal, for example in metadata such as a descriptor in a table in an MPEG transport stream, although many other options are also available such as watermarking.

The receiver extracts the indication carried in the signal and determines therefrom its locale. Because the indication indicates the geographical region where the signal physically can be received, and the receiver has in fact received the signal, it follows that the receiver must be in this geographical region.

The receiver may be coupled (e.g. via a home network) to one or more other devices. In that case the receiver can transmit its determined locale to the other devices so that these also learn in which region they are located.

If a plurality of signals is received, each of them may carry its own indication. It is possible that these indications differ, for example if the receiver is at a country border or if one indication is a subset of another. In that case the receiver needs to employ some protocol to evaluate the indications in order to determine its locale, Several embodiments of the invention provide such suitable protocols.

Preferably the indication of the geographical region is a set of geometrical shapes, such as rectengles, circles on ovals. The receiver can then compute the intersection of the sets carried in the various signals it received as the geographical region it is in. This locale can then be stored in the receiver as one or more geometrical shapes as well.

Content can carry an indication of a geographical region in which the content is allowed to be played back, recorded, retransmitted etcetera. Based on its determined locale the receiver can restrict access to such content. The receiver then compares the indicated region with its own locale and will refuse to play, record or retransmit the content if the two do not match. If the indications are sets of geometrical shapes, refusal occurs if the intersection of the sets is the empty set.

By itself positioning systems for mobile phones are known, in which the mobile phone sends the IDs transmitters masts it detects (with associated power levels) to a server. The server returns the location of the phone using an SMS message. This message does not include the location of the masts as this information is kept secret in order to maintain there competitive advantage. For details see the Internet addresses www.infosyncworld.com/news/n/1999.html and www.infosyncworld.com/news/n/2990.html

Advantageous embodiments are set out in the dependent claims.

These and other aspects of the invention will be apparent from and elucidated with reference to the embodiments shown in the drawing, in which:

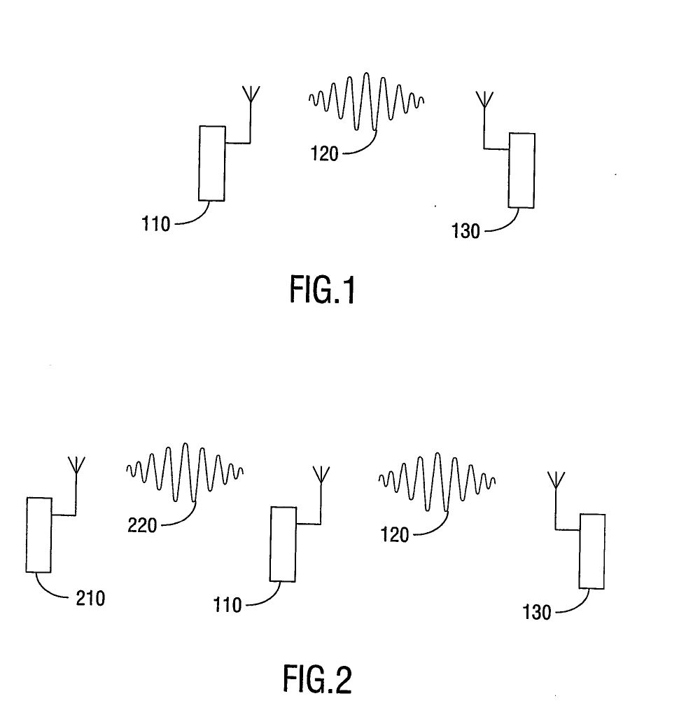

FIG. 1 schematically shows a transmitter for transmitting a signal for reception by a receiving device;

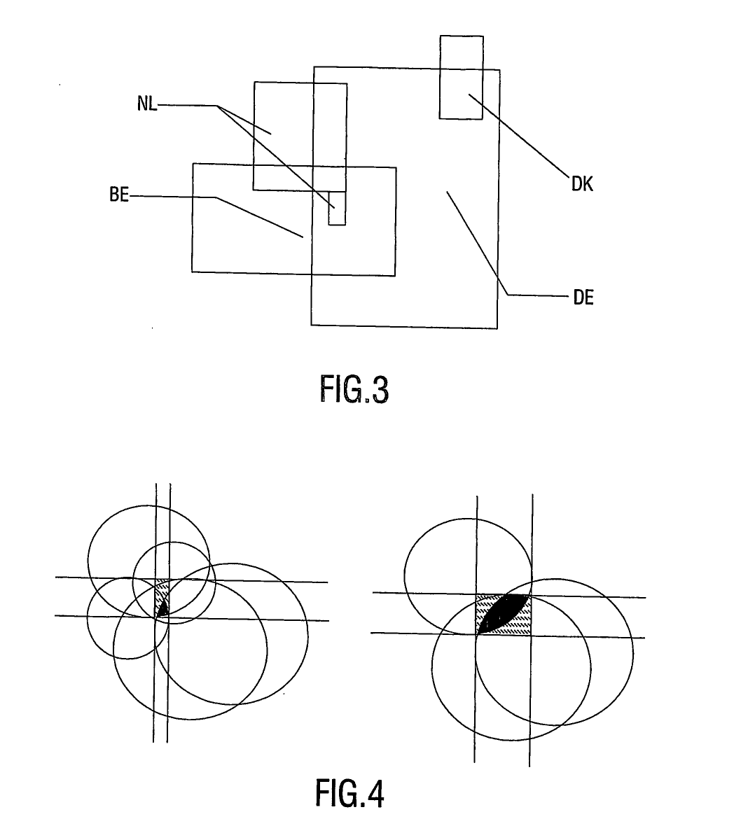

FIG. 2 shows another embodiment in which the transmitter receives the signal from another transmitter, FIG. 3 shows a set of rectangles representing the geographical regions of the Netherlands (NL), Belgium (BE), Danmark (DK) and Germany (DE);

FIG. 4 illustrates the computation of an overlap area;

Throughout the figures, same reference numerals indicate similar or corresponding features. Some of the features indicated in the drawings are typically implemented in software, and as such represent software entities, such as software modules or objects.

FIG. 1 schematically shows a transmitter 110 for transmitting a signal 120, preferably a broadcast signal, for reception by a receiving device 130, In accordance with the invention, the transmitter 110 is arranged to insert into the signal 120 an indication of a geographical region where the signal 120 physically can be received.

In this document the term “transmitter” is used broadly as any device or system that can transmit a signal to a recipient. Possible embodiments include analog or digital television broadcasting systems or cable networks.

Determining where the signal 120 can be received physically can be done in a variety of ways. A straightforward method is to employ a receiver that moves around in the area around the transmitter, and to record where the receiver still can and can no longer receive the signal. Based on data like the height of the antenna, transmitter power level and terrain data it is also possible to compute the area that will be covered by the transmission. For more information the reader is referred to handbooks such as R. E. Collin, Antennas and radio wave propagation, McGraw-Hill Higher Education; 4th edition, February 1985; M. P. M. Hall, Propagation of radiowaves, IEEE Publishing, November 1996; C. H. Papas, Theory of electromagnetic wave propagation, Dover Pubns, October 1988; or D. S. Jones, Methods in EM wave propagation, Clarendon Publishing, September 1995.

Receivers that comply with the DVB standards can be provided the region information as part of the DVB signals. The signals they depend on are only available in a very specific area (DVB-C: a city, DVB-IPI: an address). This information can be provided to the device. This information can be provided using service provider-specific protocols or by embedding the location information into the streams received by the receiver in the same way as for satellite and terrestrial receivers.

The location of the devices connected to a non-IPI network can be determined by providing information in the signals they are receiving. In the case of DVB-C devices this is the location of the cable network (always one area). For DVB-T receivers the location can be determined from the signals they can receive (typical multiple areas). It is more difficult for DVB-S devices as the area in which the signals can be received is huge. But still, an estimate can be made.

The BBC provides on its Website at

www.bbc.co.uk/reception/tv_transmitters/index.shtml an overview of main transmitters for use in the DVB-T system in the UK. Using the information on the Website it is possible to determine the position within approximately 150 km. When relay stations are used, an accuracy of say 40 km can be reached.

The report Reaching the Audience: An Analysis of Digital Broadcast Power and Coverage by Mark R. Fratrik, prepared for the Association of Maximum Service Television, Inc., October 2003 and available on the Internet at

www.mstv.org/docs/DTVRptFinal.pdf provides similar information on transmitters in the USA, thus allowing a similar computation as for the DVB-T system in the UK discussed above.

FIG. 2 shows another embodiment in which the transmitter 110 receives the signal 120 from another transmitter 210. For example, transmitter 110 may be retransmitting satellite signals over a cable network. The original signal 220 then contains an indication of the geographical region in which it can physically be received. The transmitter 110 should now replace in the signal 220 this original indication with the indication of the geographical region in which the retransmitted signal 120 can be received.

This embodiment is useful for instance when the transmitter is a head-end, such as would be used if the DVB based method is used. The head-end transmitter receives the original signal 220 from the other transmitter 210 and must update the region indication in the signal 220 before retransmitting it as signal 120. More specifically the head-end may replace a “wide” region indication (such as “European Union” or “United Kingdom”) with a more narrow region which it specifically covers (e.g. “London” or “Wales”).

The indication where the signal 120 physically can be received can be present in the content for example using a watermark or in a side channel. If an MPEG transport stream is used, the indication can be inserted in a table, either an existing table or a newly added table. For instance the Transport Stream Description Table (TSDT) or the Network Information Table (NIT) can be used.

Location can be encoded in many ways. It can be done in a coordinate system or using human readable variants like:
EU, NL, Eindhoven, Prof.Holstlaan, WY
EU, FR, Tarn, Albi, Carmaux, Pampelonne, Lunaget, LeLabot
EU, NL, Lopik

The advantages of such a system are that they are can communicate with a user (even entered by a user). The disadvantages of such a system are that if it is needed to indicate where a signal can be received with sufficient detail, the more detailed information increases rapidly.

The location can be encoded as one region indication or as a set of region indications, for example “England, Wales”.

Another approach is to use coordinates. However, these have the disadvantage that it is difficult to describe irregular shapes. Basic shapes like circles/rectangles/trapezoids/ovals can be described relatively easily. Describing the coordinates of the area covered by, say, France is far more complex. The position can only be determined with certain accuracy.

The region in which a signal can be received can also be determined using the location of the receiver, the power of the transmitter and the received power. Based on this information, the distance of the receiver to the antenna can be estimated according to the following formula:

$${R}_{i} = \sqrt{\frac{{P}_{br , i}}{{P}_{rec , i}}} .$$

In this formula, Rᵢ indicates the geographical region around transmitter i, P_{br,i} is the broadcast power of transmitter i and P_{rev,i} is the received power of transmitter i. Such calculations are expected to be error prone, due to that they are highly dependent on the antenna shapes. A more straightforward way that requires less resources is to indicate the receiving area at the transmitter 110 as the area in which a signal can be received above a certain power threshold instead of relying on calculations in the receiver 130,

In such an embodiment the transmitter 110 inserts its broadcast power level to be used for the transmission of the signal 120 in the signal together with an indication of its location. The receiver 130 can read out this information from the signal 120 and apply the above formula to estimate the distance between transmitter 110 and receiver 130, That distance and the location of the transmitter 110 give the receiver 130 an estimate of its locale. For this embodiment the receiver 130 must also comprise means to determine the received power of the transmitter 110.

Of the mathematical shapes, the shapes using straight lines allow for the easiest computation. The circular shapes best match the areas of covered by radio signals. Due to curvature of the earth, especially for large areas, the trapezoid is a better shape than the rectangle. It gives a reasonable approximation of the area covered between two longitude and two latitude values.

Another discussion to be had is whether an area is described using one or a set of figures. For transmitters a circle is a good first order approach to the reception area. For transmitters with directional antennas, a set of ovals would be a better approximation.

In the case of countries, a set of rectangles seems to be a good approximation and thus is a preferred implementation. An illustration is given in FIG. 3. FIG. 3 shows a set of rectangles representing the geographical regions of the Netherlands (NL), Belgium (BE), Danmark (DK) and Germany (DE).

Given such a set of rectangles as an indication in the signal 120, the receiver 130 can determine its locale by simply storing this set of rectangles in a local memory. If the receiver 130 is connected to another device, the receiver 130 can then transmit the set to that other device. This way, for example a residential gateway can inform all devices in a household what their locale is.

The receiver 130 may subsequently receive content carrying an indication of a geographical region in which the content may be accessed. For example, a movie may be broadcast solely for reception in the Netherlands. The receiver 130 may then access the content only if the geographical region indicated in the content overlaps with the locale it determined it is in.

The indication of the region in which the content may be accessed is preferably also provided as a set of geometrical shapes approximating the region. If the locale was determined as the set of rectangles or other geometrical shapes mentioned above, overlap can be determined by simply computing the intersection of the stored set of shapes and the set of shapes carried in the content.

The indication can be present in the content for example using a watermark or in a side channel. If an MPEG transport stream is used, the indication can be inserted in a table, either an existing table or a newly added table. These options are discussed below.

The receiver 130 is likely to receive multiple signals from multiple different transmitters. As a result, it is to be expected that the receiver 130 will also receive multiple different indications of different geographical regions. For example, the receiver 130 could be at the Dutch/Belgian border and receive signals from both Dutch and Belgian transmitters, each indicating their respective countries. Another possibility is that one signal is received indicating for example the entire United Kingdom and another indicating the principality of Wales. The receiver 130 now needs to derive from these multiple indications its actual locale. Some options to deal with this situation are:
Pick the locale from an indication that occurs most often, i.e. the largest number of receptions from a certain area
Pick the locale from the indication carried in the signal with the relatively highest received signal strength—this indicates the receiver is closest to the transmitter of that signal
Pick the locale from the indication carried in the signal with the relatively lowest transmitted signal strength—this indicates the receiver is likely in the region covered by the transmitter of that signal
Compute the overlap of the various indicated regions, for example by computing the intersection of all received geometrical shapes
All options using the power of the signal require that the power of the transmission is included in the metadata and that the receiver has to measure the power of the received signal. The largest number of channels relies on a homogeneous distribution of channels over a certain area which is not true. The preferred solution is to determine the overlap area for the different signals. This is easier in the case that the area a signal can be received in, is coded in rectangles. Also in case circles are used to estimate the reception area, rectangular solutions provide reasonable solutions.

FIG. 4 illustrates the computation of an overlap area. The receiver 130 has received a number of indications, graphically represented as circles in Fig. X. The intersection between all circles is indicated in black. An overlap area has been computed and is indicated with hashing. This overlap area was computed as a rectangle with upper left corner (x_{left}, yᵤₚ) and lower right corner (x_{right}, y_{down}) although many other ways to express rectangles are of course possible. To compute these coordinates the following formula is used:
x_{left}=max(xᵢ−Rᵢ)
x_{right}=min(xᵢ+Rᵢ)
yᵤₚ=min(yᵢ+Rᵢ)
y_{down}=max(yᵢ−Rᵢ)
where xᵢ and yᵢ are the X and Y coordinates of circle i and Rᵢ is the radius of circle i.

This leaves the question of what to do in case of a conflict, or what to do when an overlap cannot be calculated. In principle, the reception areas of the transmitters should be chosen in such a way that this cannot happen. In the case that is happens, there are several ways in which this issue can be addressed. For instance the user can be prompted to make a selection, or some of the areas could be omitted from the calculation, e.g. the ones from transmitters with the lowest signal strength.

To insert the indication of the region in the signal 120, many options are available as stated above. A preferred embodiment focuses on signals in the form of the MPEG-2 transport streams, more specifically, DVB signals. The information can then be coded into the stream as a new table or as a descriptor in an existing table.

A new table especially for location information has advantages and drawbacks. A special table is useful in the case that the amount of information to be carried is large, to manage the overhead specific for this information and/or for easy remultiplexing.

In case the information is embedded in existing tables, the NIT or TSDT are the best candidates. The location information is very stable and will not change often. The same is true for the NIT and TSDT information. So it makes sense to add the location information to the NIT information table and/or to the TSDT table, thereby avoiding the need to add another table and to transmit the location information too frequently by adding it to an often-repeated table.

Information in tables is carried using descriptors, so location information will be encoded in the descriptor format A consequence of this approach is that the information length should not be larger than 255 bytes.

In this preferred embodiment, the reception area is best described according to the table below:

| | | |
|---|---|---|
| Description | Type | Length |

reception_area_descriptor
{

| | | |
|---|---|---|
| tag | uimsbf | 8 |
| length | uimsbf | 8 |

for(i=0; i<N; i++)
{

| | | |
|---|---|---|
| longitude_left_angle | uimsbf | 16 |
| longitude_left_sec | uimsbf | 8 |
| longitude_left_min | uimsbf | 8 |
| latitude_left_angle | uimsbf | 16 |
| latitude_left_sec | uimsbf | 8 |
| latitude_left_min | uimsbf | 8 |
| longitude_right_angle | uimsbf | 16 |
| longitude_right_sec | uimsbf | 8 |
| longitude_right_min | uimsbf | 8 |
| latitude_right_angle | uimsbf | 16 |
| latitude_right_sec | uimsbf | 8 |
| latitude_right_min | uimsbf | 8 |

}

}

Optionally, the signal 120 may comprise additional information representing geographical regions where signals to be transmitted by other transmitters physically can be received. The receiver 130 in this case should determine whether it can receive those signals from those other transmitters. If not, then these geographical regions should not be included in the locale the receiver 130 determines. If those signals cannot be received, the receiver 130 apparently is not in the region where such signals can be received.

However there is the risk that due to transmission errors or other problems those signals may not be received even though the receiver 130 is in fact in the right region. To reduce this risk it is recommended that these geographical regions are taken into account only temporarily, or to repeat the determination procedure if those other signals are received at a later point in time.

For instance, geometrical shapes representing these geographical regions can be subtracted from the geometrical shapes in the signal 120 representing the region where the signal 120 transmitted by the transmitter 110 physically can be received.

In any device claim enumerating several means, several of these means can be embodied by one and the same item of hardware. The mere fact that certain measures are recited in mutually different dependent claims does not indicate that a combination of these measures cannot be used to advantage.

It should be noted that the above-mentioned embodiments illustrate rather than limit the invention, and that those skilled in the art will be able to design many alternative embodiments without departing from the scope of the appended claims.

For the purposes of this invention, the term “accessing” includes any and all processes that access and process the content material, including but not limited to: copying, playing, displaying, and so on. Similarly the term “copying” includes any and all processes that produce a copy of the content material in any of a variety of forms, including storing the material, providing the material on a removable storage device, transmitting the material to a remote device, and so on.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

1. A transmitter for transmitting a signal for reception by a receiving device, the transmitter being arranged to insert into the signal an indication of a geographical region where the signal physically can be received.

2. The transmitter of claim 1, arranged to transmit the signal over a broadcast channel.

3. The transmitter of claim 1, arranged to receive the signal from another transmitter and to replace in the signal an indication of a geographical region present in the signal with the indication of the geographical region where the signal to be transmitted by the transmitter physically can be received.

4. The transmitter of claim 1, arranged to insert as the indication a power level to be used for the transmission of the signal together with an indication of the location of the transmitter.

5. The transmitter of claim 1, in which the geographical region is indicated in the signal using geometrical shapes.

6. A receiving device for receiving one or more signals, each of the signals carrying an indication of a respective geographical region where the respective signal physically can be received, the device being arranged to determine its locale from said indications.

7. The receiving device of claim 6, being arranged to determine its locale from an indication that occurs most often in said indications.

8. The receiving device of claim 6, being arranged to determine its locale from the indication carried in the one of the respective received signals that was received with a relatively highest signal strength.

9. The receiving device of claim 6, being arranged to determine its locale from the indication present in the one of the respective received signals that was received with a relatively lowest signal strength.

10. The receiving device of claim 6, being arranged to determine its locale as an intersection of the respective geographical regions.

11. The receiving device of claim 6, in which the indication is representative of a power level used by the transmitter, the receiving device being arranged to measure a received power level of a received signal and the determination is made on the basis of the indication and the received power level.

12. The receiving device of claim 6, in which the geographical regions are indicated in the signals using geometrical shapes.

13. The receiving device of claim 6, being arranged to transmit an indication of its determined locale to another device.

14. The receiving device of claim 6, being arranged to receive content carrying an indication of a geographical region in which the content may be accessed, and being arranged to access the content if the geographical region indicated in the content overlaps with the determined locale.
